(19) United States
(12) Patent Application Publication
(10) Pub. No.: US 2025/0102068 A1
(43) Pub. Date: Mar. 27, 2025

(54) CLOSING ELEMENT FOR A VALVE

(71) Applicant: FIREDOS GMBH, Wölfersheim (DE)

(72) Inventors: Alexander SCHLEPP, Buseck (DE); Andreas HULINSKY, Dresden (DE)

(21) Appl. No.: 18/730,884

(22) PCT Filed: Jan. 24, 2023
(86) PCT No.: PCT/EP2023/051612

§ 371 Date: Jul. 22, 2024

(30) Foreign Application Priority Data
Jan. 26, 2022 (DE) 10 2022 200 850.2

(51) Int. Cl. F16K 1/38; A62C 35/68; B33Y 80/00; F16K 25/00

(52) U.S. Cl. CPC F16K 1/38; A62C 35/68; F16K 25/005; B33Y 80/00

(57) ABSTRACT

A closing element for a valve, comprising
an upstream closing element side;
a downstream closing element side; and
a valve seat surface, wherein both closing element sides have a favorable shape in terms of flow and the valve seat surface is formed between the upstream closing element side and the downstream closing element side.

The entire content of priority application DE 10 2022 200 850.2 is hereby incorporated into the present application by reference.

The present invention relates to a closing element for a valve, a valve having such a closing element, and a proportioning system for fire extinguishing systems having such a closing element or such a valve.

A closing element in the sense of the present invention is a component of a valve which in particular is moved substantially parallel to a direction of flow of a fluid. The flow is interrupted when the valve seat surface of the closing element positively seals or is positively sealed to a valve seat of the valve.

A valve in the sense of the present invention is a component for blocking or controlling the flow of fluids, particularly liquids and/or gases, through an in particular tubular line.

The following will describe closing elements and valves comprising closing elements according to the invention partly on the example of fire extinguishing systems. This is not, however, to be understood as limiting The invention can just as equally be used as a closing element for valves in other systems or in other contexts. A closing element for valves according to the invention can in particular be used in fire extinguishing systems, particularly fire extinguishing systems comprising a proportioning system.

Closing elements for valves must function reliably, particularly in proportioning systems for fire extinguishing systems. The same holds true for closing elements for valves used with disparate fluids or media respectively, particularly of different viscosities, such as the case with extinguishing agents, extinguishing agent additives, premix (mixture of an extinguishing agent and an extinguishing agent additive), etc.

There is a noticeable trend among fire extinguishing systems toward higher viscosity fluids, particularly in the case of foaming agents as extinguishing agent additives. This can have an impact on fire extinguishing system efficiency, in particular the degree of efficiency of pumps for foaming agents. In particular, this can thereby change the requirements on closing elements of valves as their respective closing element sides can be exposed to different fluids when in a closed state, in particular a foaming agent on one closing element side and in particular air on another closing element side.

These conditions in particular (higher viscosity and/or different fluids) can give rise to the problem of changing dynamic requirements for a closing element, particularly depending on the extinguishing agent additive.

The invention is therefore based on the task of improving a closing element for a valve, and in particular a valve having such a closing element, in particular a valve to be used with fluids or media of higher viscosity compared to water.

This task is in each case solved by the teaching of the independent claims. Advantageous embodiments are found in the dependent claims. In particular, the task is solved by a closing element, a valve and a proportioning system in accordance with one of the claims.

A closing element for a valve according to the invention comprises an upstream closing element side, a downstream closing element side and a valve seat surface, wherein both closing element sides have a favorable shape in terms of flow. Furthermore, the valve seat surface is formed between the upstream closing element side and the downstream closing element side.

A favorable shape in terms of flow within the meaning of the invention is a shape which offers little resistance to the fluid (or medium) in use, particularly in comparison to a closing element having disk-shaped or spherical closing element sides. A favorable shape in terms of flow within the meaning of the invention is in particular a shape which has a lower drag coefficient (more precisely flow resistance coefficient) compared to a closing element with disk-shaped or semispherical closing element sides. In particular, “flow-favorable” can refer to a resistance coefficient adapted to a specific fluid which is lower than with a closing element having disk-shaped or semispherical closing element sides. In particular, “flow-favorable” relates to the geometric shape of the closing element sides, in particular the geometric shape of the closing element body.

The inventive closing element is in particular not of (substantially) spherical form, in particular the closing element sides are not of (substantially) semispherical form.

Preferably, the upstream closing element side, the downstream closing element side and/or the valve seat surface are each rotationally symmetrical with respect to a central axis of the closing element extending in the direction of flow. Further preferably, the entire closing element is rotationally symmetrical with respect to said central axis.

As defined by the invention, “between the upstream closing element side and the downstream closing element side” refers to the valve seat surface; i.e. the valve seat surface being a surface on the closing element which is (at least substantially) independent of the two closing element sides and in particular a surface (at least substantially) independent of the surface of the upstream closing element side and the surface of the downstream closing element side. A “surface of the upstream closing element side and the downstream closing element side” is to be understood herein as referring to the respective closing element side surface.

Advantageously, this can thereby enable better flow of an in particular (highly) viscous fluid around the closing element, particularly a fluid of higher viscosity than water. Furthermore thereby enabled is the closing element offering less resistance to the surrounding fluid(s) during the opening or closing of the valve.

According to one preferential embodiment of the invention, the valve seat surface is formed on a valve plate. In other words, the part of the closing element comprising a valve seat surface can be formed as a valve plate between the upstream closing element side and the downstream closing element side. The valve plate thereby in particular has a greater extension in a direction perpendicular to the flow direction than the upstream closing element side or the downstream closing element side. The closing element section designed as a valve plate comprising the valve seat surface can be of particularly flow-favorable design. In particular, the closing element section designed as a valve plate comprising the valve seat surface can have a (flow) trailing edge on the downstream side. The valve plate can in particular be designed such that at least part of the surface of the valve plate, particularly at the maximum outer diameter of the valve plate, serves as a guide for the closing element, particularly as a guide in a valve or particularly in a valve cage respectively. This thereby advantageously enables improved alignment of the closing element during opening and closing such that there is in particular (improved) closing of the closing element.

Advantageously, a flow-favorable shape to the closing element side can reduce dead space on the respective side of the closing element.

According to a further preferential embodiment of the invention, at least one closing element side can be of conical form. In particular, both sides of the closing element can be conical.

To be understood here as “of conical form” is an increasing expansion of the closing element side from one end of the closing element toward the valve seat surface in a direction perpendicular to the direction of flow. This can in particular include surfaces or portions of the surfaces of the (respective) closing element side being or becoming rounded. Furthermore, a rounding can in particular comprise radii of (at least substantially) constant radius or of variable radius and/or Bézier curves—particularly in a sectional view of the closing element. Furthermore, conical can also be understood herein as being of frustoconical form, in other words truncated. In particular, the edges of the truncated closing element side can be or can be made rounded. Alternatively or additionally, sections of the respective closing element side's surface can be curved (at least once). The curvature can thereby be designed one-sided as well as two-sided, convex, concave, with fixed or variable curvature radii. Due to their shape and material elasticity, the (curved) surfaces can also be designed so as to be subject to an elasticity which changes the curvature and in particular by means of which the curvature adopts a more flow-favorable shape as of a specific load than in the absence of load. In particular, the (conical) upstream closing element side and/or the (conical) downstream closing element side exhibit(s) and/or adopts(s) a substantially bead-like shape.

Advantageously, this thereby enables the closing element to have a lower (flow) resistance.

According to a further preferential embodiment of the invention, the closing element can be designed to close or open at a speed of greater than 7 m/s. Alternatively or additionally, the closing element can be designed to open or close at a speed of less than 15 m/s. In particular, the closing element can be designed to open or close at a speed of less than 10 m/s. This can in particular be achieved by a shape which is favorable in terms of flow. Advantageously, the flow-favorable shape of the closing element reduces resistance to the surrounding fluid(s), in particular air and/or an extinguishing agent additive such as a foaming agent. In other words, a flow-favorable shape to the closing element can increase an opening speed and/or closing speed of the closing element, particularly because the flow-favorable shape of the closing element reduces (aerodynamic and/or hydrodynamic) resistance.

According to a further preferential embodiment of the invention, the closing element can be made of plastic. The closing element can in particular be made from a plastic having a compressive strength of more than 40 MPa. In particular, the plastic can have a compressive strength of more than 60 MPa or more than 80 MPa. One example of a plastic having a compressive strength of approximately 100 MPa is Iglidur X from manufacturer Igus. Further exemplary plastics with compressive strengths of more than 40 MPa are in particular POM (polyoxymethylene), in particular POM-C, typically at 20/35/68 MPa, or PEEK (polyether-etherketone), typically at 23/43/102 MPa, corresponding to deformation points at 1%, 2% or 5%. Advantageously, a closing element made of a plastic having a suitable compressive strength of more than 40 MPa, in particular more than 80 MPa or with a compressive strength of 40 MPa to 120 MPa, can withstand the above-cited opening and closing speeds. Furthermore, a plastic closing element advantageously enables quiet operation, particularly compared to a closing element made of metal or ceramic, in particular compared to a non-plastic material.

A compressive strength of a plastic in the sense of the present invention refers to a short-term load capacity of the respective plastic. This is for example measured by applying an increasing force to cylindrical or cube-shaped samples held between two plates. The stress and the strain are thereby measured. The compressive load is not normally specified at break but rather at a defined deformation point (generally 1%, 2% or 5%). The values used herein refer to a deformation point at 5%, in particular pursuant to the DIN EN ISO 604.

Alternatively or additionally, the closing element can in particular be made from a plastic having a tensile strength, in particular a tensile strength pursuant to the DIN EN ISO 527-2, of greater than 65 MPa, in particular greater than 80 MPa, greater than 90 MPa, greater than 100 MPa, greater than 120 MPa or greater than 140 MPa.

Alternatively or additionally, the closing element can in particular be made from a plastic having a tensile modulus of elasticity, in particular a tensile modulus of elasticity pursuant to the DIN EN ISO 527-2, of more than 2750 MPa, in particular more than 4000 MPa, more than 6000 MPa, more than 8000 MPa, more than 10000 MPa or more than 12000 MPa.

Alternatively or additionally, the closing element can in particular be made from a plastic having a flexural strength, in particular a flexural strength pursuant to the DIN EN ISO 178, of greater than 90 MPa, in particular greater than 110 MPa, greater than 130 MPa, greater than 150 MPa or greater than 170 MPa.

Alternatively or additionally, the closing element can in particular be made from a plastic having a flexural modulus of elasticity, in particular a flexural modulus of elasticity pursuant to the DIN EN ISO 178, of more than 2500 MPa, in particular more than 4000 MPa, more than 6000 MPa or more than 8000 MPa.

Alternatively or additionally, the closing element can in particular be made from a plastic having a Shore hardness, in particular a Shore hardness pursuant to the DIN EN ISO 868 scale D (DIN 53505 (withdrawn)), of greater than 75, in particular greater than 77, greater than 79, greater than 82 or greater than 85.

Alternatively or additionally, the closing element can in particular be made from a plastic having a Charpy impact strength, in particular a Charpy impact strength pursuant to the DIN EN ISO 179-1eA, of greater than 3.9 kJ/m², greater than 5 kJ/m², greater than 6 kJ/m², greater than 7 kJ/m² or greater than 7.5 kJ/m².

The closing element is preferably produced by machining, in particular as a turned part. Further preferably, the closing element can be produced by an injection molding process.

Furthermore, the closing element can be made from one or more plastics. In particular, the closing element can be produced in a multi-component process, in particular by a multi-component injection molding process and/or by multi-component printing technology. In particular, the valve seat surface can be made from a different material than the upstream closing element side or the downstream closing element side. In particular, the various closing element sections and/or closing element parts can be at least partly made from different materials. This can enable the respective sections of the closing element to capitalize on various advantageous material properties.

According to a further preferential embodiment of the invention, the closing element can be formed as a 3D printed part. Alternatively or additionally, the closing element can be formed as a fiber-reinforced plastic element. Fiber-reinforced plastics are 3D-printable. To be understood herein by “3D printed part” is a part produced by additive manufacturing, also known as generative manufacturing.

According to a further preferential embodiment of the invention, the closing element can be of one-piece design. Alternatively, the closing element can consist of two or more parts. In particular, a multi-part closing element can be made from at least one material, in particular from two or more (different) materials. The materials can in particular be of similar and/or different type. In other words, the closing element can be assembled as a multi-part closing element, in particular from two or more different metal, plastic and/or ceramic parts. Each part in particular can thereby be produced in a process suitable for the respective material. Such a process can in particular be a process from among the group of primary shaping, forming and additive/generative manufacturing.

According to a further preferential embodiment of the invention, the downstream closing element side can be of bulbous design. Advantageously, doing so can reduce dead space on the downstream side of the closing element. Bulbous here is to be understood as the closing element having a bulge on the downstream side which is suited to reducing dead space on the downstream side of the closing element. Furthermore, the closing element can additionally or alternatively be formed with a bulbous shape on an upstream closing element side; i.e. the closing element can have a bulge on the upstream closing element side and/or the upstream closing element side which is suited to reducing dead space on the respective side of the closing element.

According to a further preferential embodiment of the invention, the closing element can in particular exhibit a surface finishing, in particular a surface with a mean roughness index Rₐ of less than 1.6 μm, particularly with an average roughness depth R_{z} of less than 10 μm, particularly with a maximum roughness depth Rₘₐₓ (VDA) of less than 16 μm, particularly with a material fraction (percentage contact area) Rₘᵣ of more than 50%.

The closing element can in particular exhibit a surface coating and/or a surface finish/surface enhancement.

According to a further preferential embodiment of the invention, the closing element can in particular exhibit a ratio of length in the flow direction to width at the valve seat surface of less than 1, in particular less than 0.9. In particular, the closing element can exhibit a ratio of maximum diameter of the valve seat surface to maximum diameter of the downstream closing element side and/or the upstream closing element side of 1.3 or greater.

According to a further preferential embodiment of the invention, the closing element can be at least partially hollow. In particular, the closing element can comprise a cavity. In other words, the closing element can be formed as a hollow component. Advantageously, this thereby enables the weight of the closing element to be reduced and in particular the valve being able to open or close more quickly than particularly a heavier closing element without a cavity. Advantageously, further structural elements such as, for example, struts can be arranged in the cavity. These can significantly increase the stability of the closing element while only slightly increasing the closing element's weight. Such structural elements like struts can be provided particularly easily when producing the closing element as a 3D printed part.

Particularly a valve timing, in particular an opening speed, of the closing element (usually) relates to a 5° crank angle (5° CA) or to a crank angle difference between a closed and an open valve and vice versa of in particular less than 10° CA respectively.

A valve according to the invention comprises a closing element according to an embodiment of the invention. A valve according to the invention further comprises a housing with a fluid inlet and a fluid outlet as well as a valve seat which prevents a flow of a fluid from the fluid inlet to the fluid outlet when the valve seat surface of the closing element is positively seated on the valve seat of the valve. Advantageously, a valve with an inventive closing element can enable the faster opening or closing of the valve, particularly compared to a valve not comprising a closing element according to the invention. In particular, the valve's opening or closing can ensue more easily with an inventive closing element than without an inventive closing element, thus e.g. with a closing element from the prior art. In particular, an inventive closing element in the valve can enable lower resistance, particularly during the valve's opening or closing. The valve can in particular be designed as a non-return valve. The valve plate (or the downstream closing element side) can in particular be designed such that a seat is formed on its downstream side (on the downstream closing element side) for a reset mechanism, particularly a return spring, so that the valve can be used as a non-return valve.

According to one preferential embodiment of the invention, the valve can exhibit low lift compared to the length of the closing element. In particular, the lift can be less than 10 mm. Further particularly, the lift can be less than 8 mm. In particular, the lift can constitute less than 30% or less than 28% or less than 26% of the length of the closing element in the direction of flow. Advantageously, a low lift and a particularly fast opening speed of the valve, which in particular can be induced by the closing element having a flow-favorable shape, can enable achieving faster valve operation. Particularly able to be enabled is the valve having or being able to exhibit a faster response time, particularly in the case of fluids of higher viscosity than water or of air.

A proportioning system for fire extinguishing systems according to the invention comprises at least one valve according to an embodiment of the invention. Furthermore, the proportioning system can in particular be configured to add an extinguishing agent additive, in particular a foaming agent, to an extinguishing agent at a generally average flow rate (particularly in the valve) or feed rate respectively of typically at least 1.0 m/s, in particular at an average flow rate or feed rate of 1.0 m/s to 2.5 m/s.

A fire extinguishing system in the sense of the present invention is a system comprising an extinguishing agent pump, a system of lines and a proportioning system for extinguishing agent additive, in particular a foaming agent, with which an extinguishing agent, in particular water, can be deployed, particularly through nozzles, sprinklers, foam pipes or foam generators. The fire extinguishing system can be a stationary system such as a fire extinguishing system in a tank farm having a permanently mounted so-called monitor; i.e. a large nozzle pipe, or also a permanently mounted sprinkler system in a building. However, it can also be a mobile system on a vehicle or roll-off/on container.

Such fire extinguishing systems are usually operated with water as the extinguishing agent. There are, however, many cases in which it is advantageous to for the extinguishing agent to be foamed before being deployed onto the fire to be fought so that the deployed extinguishing agent forms a long-lasting blanket of extinguishing agent able to smother the fire. To that end, an extinguishing agent additive, here a foaming agent, is usually first mixed into the extinguishing agent at a specific ratio. The mixture of extinguishing agent/extinguishing agent additive (the so-called “premix”) is then foamed in a nozzle under a feed of air and deployed onto the fire to be extinguished. The volumetric ratio of extinguishing agent additive to extinguishing agent, the so-called proportioning rate, is typically between 0.5% and 6%.

A surfactant or “wetting agent” which reduces the surface tension of the extinguishing agent, in particular the firefighting water, is another extinguishing agent additive able to be mixed into the extinguishing agent. This is advantageous when fighting forest fires, for example, because the firefighting water thereby douses larger areas and can thus be used more efficiently. Furthermore, the reduced surface tension enables the firefighting water to penetrate deeper into solid material, in particular wood and/or the forest floor, in order to extinguish for example deeper hotspots.

There are also foaming agents likewise able to be used as wetting agents (potentially at other proportioning rates, particularly at a minimum proportioning rate of 0.1%).

Embodiments herein will to some extent be described using the example of water as an extinguishing agent and foaming agent as an extinguishing agent additive. This is not, however, to be understood as limiting. The invention can just as equally be used in the admixture of any extinguishing agent additives to any extinguishing agent.

For operating the fire extinguishing system with the proportioning system, both the extinguishing agent as well as the extinguishing agent additive can be provided in an extinguishing agent tank or an extinguishing agent additive tank or also provided via an extinguishing agent supply line or an extinguishing agent additive supply line respectively. Also required when the extinguishing agent is provided in an extinguishing agent tank is an extinguishing agent pump which pumps the extinguishing agent from the extinguishing agent tank, pressurizes it and feeds it to the proportioning system. However, the components just noted are not necessarily part of the proportioning system itself.

In the case of a foaming agent as an extinguishing agent additive, the mixture to be produced from the extinguishing agent and the extinguishing agent additive; i.e. the premix, is then conducted as a premix flow through a foaming nozzle in which ambient air is drawn in by the premix flow and mixed with the premix. This thereby activates the foaming agent in the premix and foams the premix so that an extinguishing agent foam can be discharged from the foaming nozzle and deployed onto the fire.

The air required to foam the foaming agent can also be supplied to the premix in the form of compressed air. Such a system that generates compressed air foam is called a CAFS system (Compressed Air Foam System).

Although it is possible for the premix to be produced in advance independently of the fire extinguishing system, it may then need to be stored for a longer period of time. Therefore, in many cases, it is more advantageous to not produce the premix until just prior to deploying the extinguishing agent onto the fire to be fought. To that end, the proportioning system has a mixing pump by means of which the extinguishing agent additive can be pumped and added to the extinguishing agent.

In the proportioning system relative to the present invention, the mixing pump is driven by a motor which is in turn itself driven by a flow of the extinguishing agent.

In the above-cited non-limiting application example of the invention, the proportioning system thus comprises a water motor which is driven by the flow of the firefighting water. To that end, the output shaft of the water motor is coupled to the input shaft of the mixing pump, in particular by a coupling.

The extinguishing agent additive pumped by the mixing pump is then fed through an extinguishing agent additive output line from the mixing pump into a proportioning line and into the flow of extinguishing agent there in order to produce the premix.

This configuration of the proportioning system, where the mixing pump is driven by the flow of extinguishing agent already present anyway, has the advantage of the mixing pump not requiring any external operating power, in particular electricity, whereby the proportioning system is extremely fail-safe. Furthermore, the pump capacity of the mixing pump is substantially proportional to the speed of the motor, which in turn is substantially proportional to the flow rate of the extinguishing agent flow. This thus automatically achieves a substantially constant proportioning rate without the need for additional control or regulating devices.

The mixing pump in the proportioning system is preferably a piston pump. Valves according to the invention are preferably utilized within the mixing pump in order to control the intake and output of the extinguishing agent additive into or from the individual cylinders.

The relative speed of the closing elements of the valves (opening/closing speed of typically greater than 7 m/s and/or less than 15 m/s) vis-à-vis the extinguishing agent additive (extinguishing agent additive feed rate of typically at least 1 m/s, in particular 1.0 m/s to 2.5 m/s) is thereby relatively high compared to the flow rate of the extinguishing agent additive itself. The inventive design of the closing elements with a flow-favorable shape on both closing element sides thereby proves advantageous since both sides of the closing element each move at the stated high relative speed with respect to the extinguishing agent additive.

Values for speeds and/or times may in particular refer to a typically substantially maximum capacity of the valve, in particular the system.

Further advantages, features and possible applications of the present invention will become apparent from the following description in conjunction with the figures. Thereby shown:

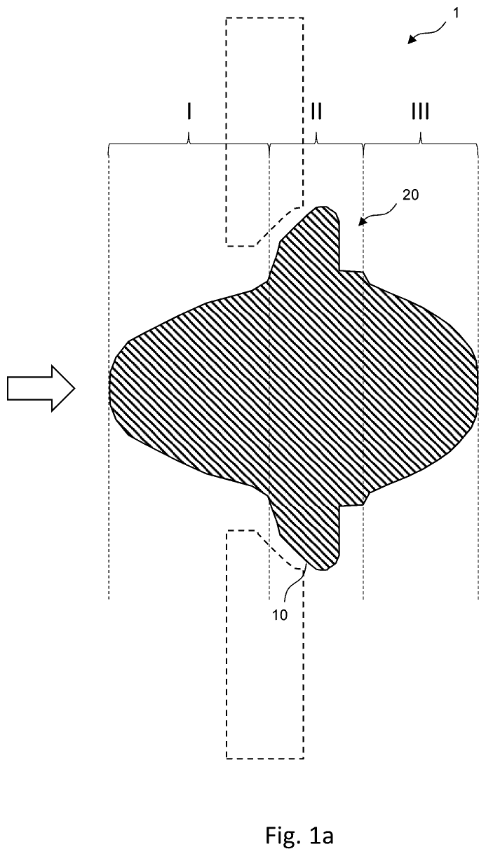

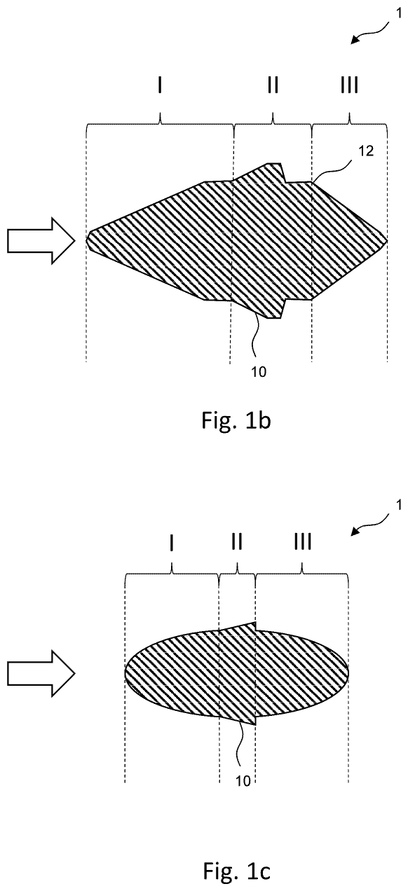

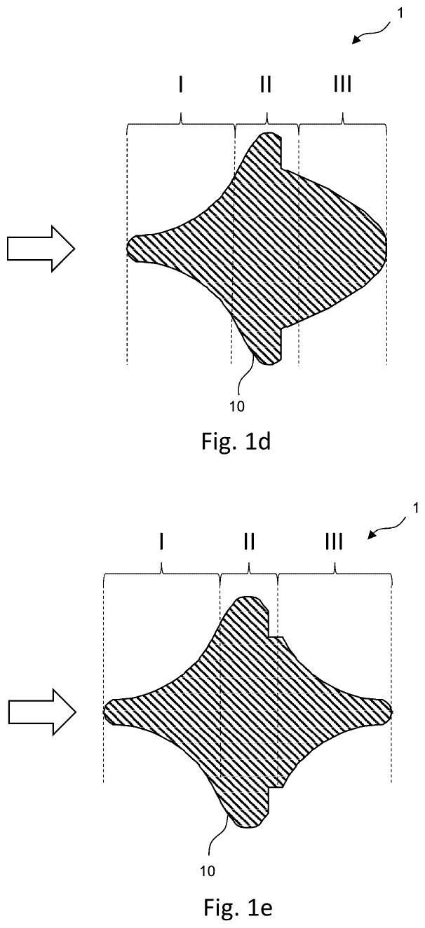

FIG. 1a a schematic sectional view through a closing element according to one exemplary embodiment with a valve plate on which a valve seat surface is formed;

FIG. 1b a schematic sectional view through a closing element according to a further exemplary embodiment;

FIG. 1c a schematic sectional view through a closing element according to a further exemplary embodiment;

FIG. 1d a schematic sectional view through a closing element according to a further exemplary embodiment exhibiting a concave curvature on one side;

FIG. 1e a schematic sectional view through a closing element according to a further exemplary embodiment exhibiting a concave curvature on both sides;

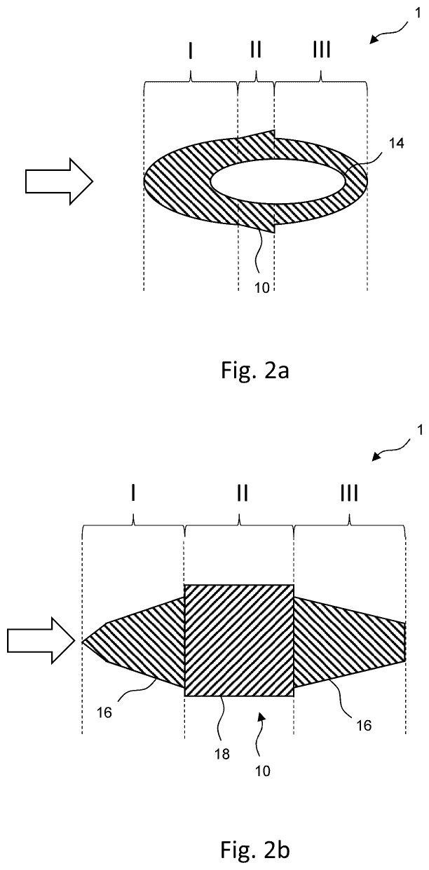

FIG. 2a a schematic sectional view through a closing element according to a further exemplary embodiment which is hollow;

FIG. 2b a schematic sectional view through a closing element according to a further exemplary embodiment comprising multiple components;

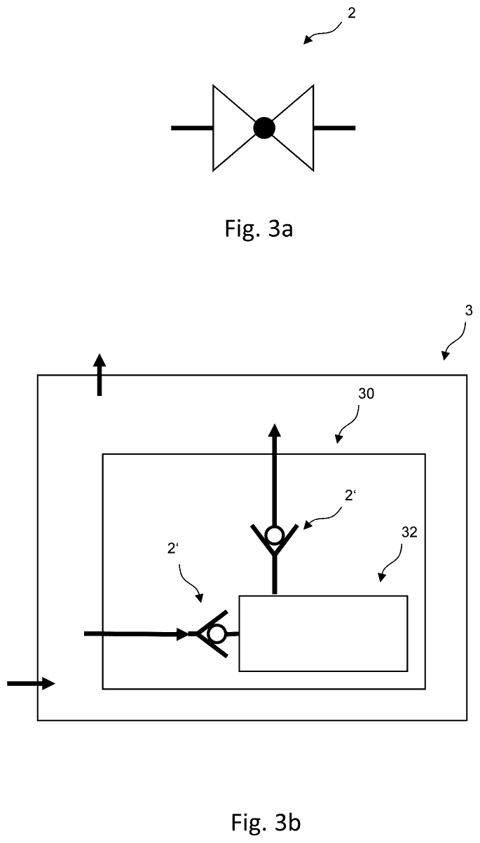

FIG. 3a a schematic view of a valve according to one exemplary embodiment; and

FIG. 3b a schematic view of a proportioning system according to an exemplary embodiment.

The schematic illustrations in particular do not reflect actual proportions but rather should be taken as exemplifying the cited embodiments. Particularly curvatures and/or the valve seat surface are thus not shown or only partially depicted.

The closing element 1 in FIG. 1a has an upstream closing element side I, a downstream closing element side III as well as a valve seat surface 10 formed on a valve plate II. The upstream closing element side I and the downstream closing element side III are of a favorable design in terms of flow. A flow direction is indicated schematically by the arrow on the left side. If a valve 2 is designed as a non-return valve 2′, the closing element 1 can comprise a seat 20 for a reset mechanism, particularly on its valve plate II. FIG. 1 shows an example of a seat 20 for a return spring.

Furthermore depicted in dashed lines in FIG. 1a is a valve seat in a valve. When a fluid now reaches the upstream side, the closing element 1 releases from the valve seat in the direction of flow so that the valve 2 opens. In other words, when the pressure on the upstream side is higher than the pressure on the downstream side of the closing element 1 and in particular overcomes a potential restoring force of a reset mechanism, in particular a return spring, the valve 2 opens and vice versa.

The closing element 1 shown is conical in shape on both the upstream closing element side I as well as the downstream closing element side III. The closing element 1 moreover exhibits rounding of the conically shaped closing element sides I, III. This flow-favorable shape of the closing element 1 has less resistance in flow (in the direction of flow), both in relation to air as well as in relation to the fluid employed. The conical design to the downstream closing element side III reduces dead space on the downstream closing element side III. A rounding can in particular also be a transition, particularly a flow-optimized transition, from the upstream closing element side I to the valve plate II, as illustratively depicted here. A rounding can likewise be a transition, particularly a flow-optimized transition, from the valve plate II to the downstream closing element side III, as illustratively depicted here.

The closing element 1 in FIG. 1b comprises an upstream closing element side I, a downstream closing element side III as well as a valve seat surface 10 formed on a valve plate II. A flow direction is also indicated schematically by an arrow on the left side. FIG. 1b shows the closing element 1 schematically with a plurality of substantially flat surfaces, these producing a substantially conical shape to the respective closing element sides I, III.

The closing element 1 in FIG. 1c comprises an upstream closing element side I, a downstream closing element side III as well as a valve seat surface 10 formed on a valve plate II. A flow direction is also indicated schematically by an arrow on the left side. As illustratively depicted in FIG. 1c, rounding of the respective closing element sides I, III can result in an overall substantially bead-like shape to the closing element.

The closing element 1 in FIG. 1d comprises an upstream closing element side I, a downstream closing element side III as well as a valve seat surface 10 formed on a valve plate II. A flow direction is also indicated schematically by an arrow on the left side. The upstream closing element side I is concavely curved. In other words, there is a concave rounding to the conical upstream closing element side I.

The closing element 1 in FIG. 1e comprises an upstream closing element side I, a downstream closing element side III as well as a valve seat surface 10 formed on a valve plate II. A flow direction is also indicated schematically by an arrow on the left side. The upstream closing element side I and the downstream closing element side II are concavely curved. In other words, there is a concave rounding to the conical upstream closing element side I and downstream closing element side III.

The closing element 1 in FIG. 2a comprises an upstream closing element side I, a downstream closing element side III as well as a valve seat surface 10 formed on a valve plate II. A flow direction is also indicated schematically by an arrow on the left side. The closing element 1 in FIG. 2a is hollow in order to reduce in particular the weight of the closing element 1. The cavity 14 can in particular be asymmetrically arranged in the closing element 1, as illustratively depicted here. Thus, in particular material thickness between the surface of the closing element 1 and the cavity 14 can vary across the closing element 1.

The closing element 1 in FIG. 2b schematically depicts a closing element 1 composed of multiple materials. In particular, the material of the valve seat surface (and/or the valve plate II) can differ from the material of the closing element sides I, III. The schematic depiction of the closing element 1 in FIG. 2b exhibits a first material 16 on the upstream closing element side I and the downstream closing element side III which differs from the second material 18 of the valve plate II. Other combinations of the first material 16 and second material 18 are in particular also possible, in particular the upstream closing element side I can encompass a first material 16 and the valve plate II and the downstream closing element side III can encompass a second material.

FIG. 3a shows a valve 2 schematically. The valve 2 comprises a closing element 1 according to an above-described embodiment.

FIG. 3b schematically shows a proportioning system 3 comprising a mixing pump, which is illustratively depicted as a piston pump 30 and comprises a piston pump cylinder 32, the valves of which are designed as non-return valves 2′. The proportioning system 3 comprises a firefighting water supply line and an output-side end of the proportioning line, each indicated as arrows.

Embodiments as described herein may be combined with one another as feasible into new embodiments.

Although exemplary embodiments have been illustrated in the preceding description, it should be noted that a plurality of modifications are possible. Additionally to be noted is that the exemplary embodiments are only examples which are in no way intended to limit the scope of protection, applications and configuration. Rather, the foregoing description is to provide the person skilled in the art with a guideline for implementing at least one exemplary embodiment, whereby various modifications can be made, particularly as regards the function and arrangement of the described components, without departing from the scope of protection as results from the claims and combinations of features equivalent to same.

### List of Reference Numerals

1 closing element
2 valve
2′ non-return valve
3 proportioning system
12 trailing edge
14 cavity
16 first material
18 second material
20 seat for return spring
30 piston pump
32 piston pump cylinder
I upstream closing element side
II valve plate
III downstream closing element side

What is claimed is:

1. A closing element for a valve, comprising:
an upstream closing element side;
a downstream closing element side; and
a valve seat surface,
wherein both closing element sides have a favorable shape in terms of flow and the valve seat surface is formed between the upstream closing element side and the downstream closing element side.

2. The closing element according to claim 1, wherein the valve seat surface is formed on a valve plate.

3. The closing element according to claim 1, wherein at least one closing element side is of a conical form, particularly both closing element sides are of the conical form.

4. The closing element according to claim 1, wherein the closing element is designed to close or open at a speed of greater than 7 m/s and/or at a speed of less than 15 m/s, in particular at a speed of less than 10 m/s.

5. The closing element according to claim 1, wherein the closing element is made from plastic, in particular from a plastic having a compressive strength of more than 40 MPa or a compressive strength of more than 80 MPa.

6. The closing element according to claim 1, wherein the closing element is formed as a 3D printed part and/or that the closing element is formed as a fiber-reinforced plastic element.

7. The closing element according to claim 1, wherein the downstream closing element side is of bulbous form.

8. A valve comprising a closing element according to claim 1, wherein the valve is a non-return valve.

9. A valve according to claim 1, wherein the valve exhibits low lift compared to the length of the closing element, in particular a lift of less than 10 mm, further particularly less than 8 mm.

10. A proportioning system for a fire extinguishing system comprising at least one valve according to claim 8, wherein the proportioning system is configured to add a foaming agent to an extinguishing agent at a feed rate of at least 1 m/s.

11. A proportioning system for a fire extinguishing system comprising at least one valve according to claim 9, wherein the proportioning system is configured to add a foaming agent to an extinguishing agent at a feed rate of at least 1 m/s.
